(19) United States
(12) Patent Application Publication
(10) Pub. No.: US 2024/0088535 A1
(43) Pub. Date: Mar. 14, 2024

(54) SECONDARY BATTERY CELL

(71) Applicant: SK On Co., Ltd., Seoul (KR)

(72) Inventor: Jae Sik SHIN, Daejeon (KR)

(21) Appl. No.: 18/461,516

(22) Filed: Sep. 6, 2023

(30) Foreign Application Priority Data
Sep. 13, 2022 (KR) 10-2022-0114664

(51) Int. Cl. H01M 50/581; H01M 50/103; H01M 50/119; H01M 50/15; H01M 50/586

(52) U.S. Cl. CPC H01M 50/581; H01M 50/103; H01M 50/119; H01M 50/15; H01M 50/586; H01M 2200/10

(57) ABSTRACT

A secondary battery cell includes an electrode assembly having a negative electrode and a positive electrode alternately stacked with a separator therebetween, a case accommodating the electrode assembly and including an opening in at least one side, a cap plate assembly disposed to cover the opening and including at least one of a negative electrode terminal connected to the negative electrode and a positive electrode terminal connected to the positive electrode, and a short-circuit inductor accommodated inside of the case and inducing a short circuit between a member having a negative polarity and a member having a positive polarity when the inside of the case is at a predetermined temperature or higher.

### CROSS-REFERENCE TO RELATED APPLICATION(S)

This patent document claims the priority and benefits of Korean Patent Application No. 10-2022-0114664 filed on Sep. 13, 2022, the disclosure of which is incorporated herein by reference in its entirety.

### TECHNICAL FIELD

The technology and implementations disclosed in this patent document generally relate to a secondary battery cell, and more particularly, to a prismatic secondary battery cell.

### BACKGROUND

Unlike primary batteries, secondary batteries are characterized by being able to be used repeatedly through recharging, and may be applied as an energy source in various fields such as digital cameras, laptops, mobile terminals, electric vehicles, hybrid vehicles and the like. Among secondary batteries, lithium secondary batteries are the most representative, and in addition, there are nickel-cadmium batteries, nickel-hydrogen batteries, and the like.

Such a secondary battery may be manufactured and used as a rigid prismatic or cylindrical type battery cell or a flexible pouch type battery cell, and in the case of electric vehicles requiring high output characteristics and the like, the secondary battery may be used in the form of a battery module including one or more cell stacks in which a plurality of battery cells are stacked or a battery pack including one or more such battery modules.

On the other hand, requirements for safety are gradually increasing due to the nature of product groups to which secondary batteries are applied. In detail, in the case of electric vehicles equipped with a plurality of battery cells, ignition of one battery cell may propagate to adjacent battery cells, causing chain ignition and consequent thermal runaway.

### SUMMARY

The disclosed technology can be implemented in some embodiments to provide a secondary battery cell having improved safety. In detail, the disclosed technology can be implemented in some embodiments to provide a secondary battery cell designed not to lead to ignition by intentionally inducing a short circuit at a predetermined temperature or higher.

In some embodiments of the disclosed technology, a secondary battery cell includes an electrode assembly having a negative electrode and a positive electrode alternately stacked with a separator therebetween; a case accommodating the electrode assembly and including an opening in at least one side; a cap plate assembly disposed to cover the opening and including at least one of a negative electrode terminal connected to the negative electrode and a positive electrode terminal connected to the positive electrode; and a short-circuit inductor accommodated inside of the case and inducing a short circuit between a member having a negative polarity and a member having a positive polarity when the inside of the case is at a predetermined temperature or higher.

The short-circuit inductor may include a first structure formed of a conductive material connected to the member having the negative polarity; a second structure formed of a conductive material connected to the member having the positive polarity; and an insulating structure formed of an insulating material contacting the first structure and the second structure simultaneously.

The insulating structure may be disposed between the first structure and the second structure and may be a solid-state material having an arbitrary shape.

The first structure and the second structure may maintain a state of being spaced apart from each other by the insulating structure when the inside of the case is lower than a predetermined temperature, and may be at least partially in contact with each other when the inside of the case is a predetermined temperature or higher.

The first structure and the second structure may be disposed such that respective ends face each other with the insulating structure interposed therebetween.

At least one of the first structure and the second structure may include a void in an end, and a portion of the insulating structure may be disposed in the void.

The void may have a cross-sectional area larger than a cross-sectional area of the end of the first structure or the second structure facing the void, and the end of the first structure or the second structure facing the void may be not a void.

The insulating structure may be formed of a material having a melting point of 110° C. or more and 150° C. or less.

The insulating structure may be formed of a polyethylene (PE) material or a polypropylene (PP) material.

The case may be formed of a material containing aluminum, and the second structure may be connected to the case.

The second structure may be formed of the same material as a material of the case.

The electrode assembly may include an uncoated portion led out in a longitudinal direction of the negative electrode or the positive electrode, the cap plate assembly may include a current collector plate structurally and electrically connected to the uncoated portion, and the first structure may be connected to the current collector plate.

The first structure may be formed of the same material as a material of the current collector plate.

The case may have a rectangular parallelepiped shape.

### BRIEF DESCRIPTION OF DRAWINGS

Certain aspects, features, and advantages of the disclosed technology are illustrated by the following detailed description with reference to the accompanying drawings.

FIG. 1 is a perspective view of a secondary battery cell according to an embodiment.

FIG. 2 is an internal cross-sectional view of the secondary battery cell of FIG. 1.

FIG. 3 is an enlarged view of a portion to which a short-circuit inductor is applied in FIG. 2.

FIG. 4A is a view illustrating a state before operation of the short-circuit inductor, and FIG. 4B is a view illustrating a state after operation of the short-circuit inductor.

FIG. 5 is a graph of stability test results of a secondary battery cell according to an embodiment.

FIG. 6 is a perspective view of a secondary battery cell according to another embodiment.

FIG. 7 is an internal cross-sectional view of the secondary battery cell of FIG. 6.

### DETAILED DESCRIPTION

Features of the disclosed technology disclosed in this patent document are described by example embodiments with reference to the accompanying drawings.

Prior to the detailed description of the disclosed technology, the terms or words used in this specification and claims should not be construed as being limited to common or dictionary meanings, and it should be interpreted as meaning and concept consistent with the technical spirit of the disclosed technology, based on the principle that the inventor may appropriately define the concept of the term in order to describe his or her invention in the best manner. Therefore, the embodiments described in this specification and the configurations illustrated in the drawings are only the preferred embodiments of the disclosed technology, and do not represent all the technical ideas of the disclosed technology. Therefore, it should be understood that there may be various equivalents and modifications that may be substituted for the same.

In the following description, singular expressions include plural expressions unless the context clearly dictates otherwise. Terms such as “comprise” or “include” are intended to indicate that the features, numbers, steps, operations, components, parts, or combinations thereof described in the specification exist. Therefore, it should be understood that it does not preclude the possibility of the presence or addition of one or more other features, numbers, steps, operations, components, parts, or combinations thereof.

Also, in the present specification and claims, terms including ordinal numbers such as “first,” “second” and the like may be used to distinguish between elements. These ordinal numbers are used to distinguish the same or similar components from each other, and the meaning of the terms should not be construed as being limited due to the use of these ordinal numbers. For example, elements combined with such ordinal numbers should not be construed as limiting the use order, arrangement order or the like by the number. If necessary, respective ordinal numbers may be used interchangeably.

Hereinafter, embodiments of the disclosed technology will be described with reference to the accompanying drawings. However, the spirit of the disclosed technology is not limited to the presented examples. For example, a person skilled in the art who understands the spirit of the disclosed technology may suggest other embodiments included in the scope of the spirit of the disclosed technology through the addition, change, or deletion of elements, and this will also be included within the scope of the spirit of the disclosed technology. The shapes and sizes of elements in the drawings may be exaggerated for clarity.

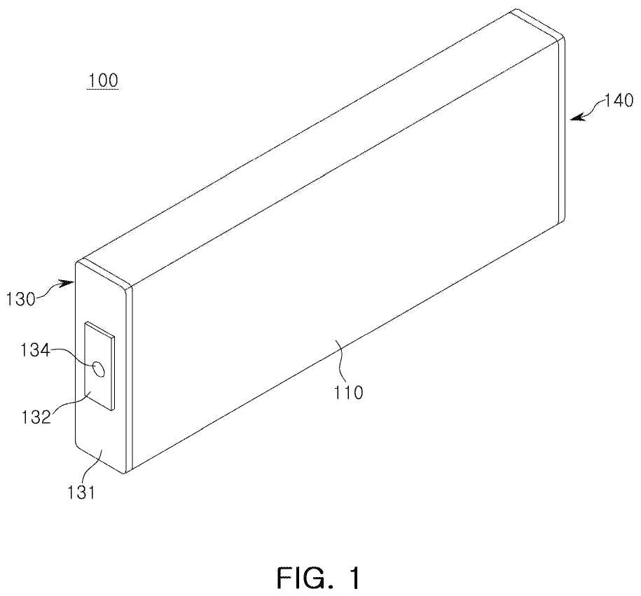

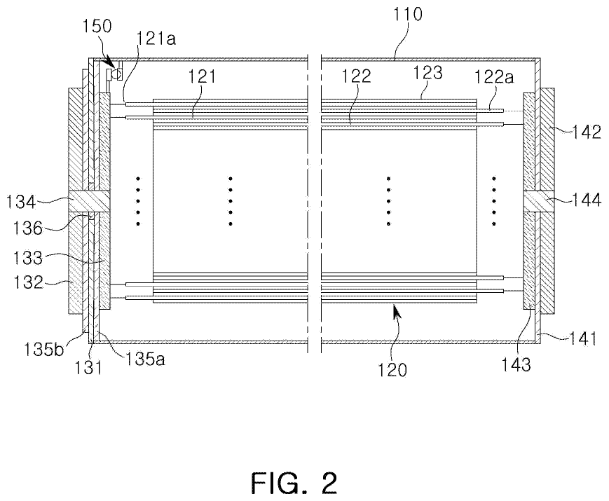

FIG. 1 is a perspective view of a secondary battery cell according to an embodiment, and FIG. 2 is an internal cross-sectional view of the secondary battery cell of FIG. 1.

A secondary battery cell 100 according to an embodiment may be a prismatic secondary battery cell packaged in a quadrangular shape.

A case 110 of the prismatic secondary battery cell 100, having a quadrangular, may be formed of aluminum, and accordingly, in the case of the prismatic secondary battery cell 100, the case 110 may be designed to have a positive polarity.

According to an embodiment, an electrode assembly 120 and an electrolyte may be accommodated inside the case 110 of the prismatic secondary battery cell 100.

The electrode assembly 120 may include a negative electrode 121, a positive electrode 122 and a separator 123. The electrode assembly 120 may have a form in which the negative electrode 121 and the positive electrode 122 are alternately stacked with the separator 123 interposed therebetween, or may have a wound shape in a stacked state.

The negative electrode 121 and the positive electrode 122 may be formed by coating an electrode active material on a current collector in the form of a thin film (or foil) having a thickness of about 10 μm.

For example, the negative electrode 121 may be formed by coating an electrode active material such as graphite or carbon on a current collector such as copper, a copper alloy, nickel, or a nickel alloy. On the other hand, the positive electrode 122 may be formed by coating an electrode active material such as a transition metal oxide on a current collector such as aluminum or aluminum alloy. However, the materials of the current collectors of the negative electrode 121 and the positive electrode 122 and the electrode active material are not limited to the materials mentioned above as examples.

On the other hand, the negative electrode 121 and the positive electrode 122 may include uncoated portions 121a and 122a, which are regions on which the electrode active material is not applied to the current collector.

The uncoated portions 121a and 122a may be portions extending in the longitudinal direction of the negative electrode 121 and the positive electrode 122. The uncoated portions 121a and 122a may be electrically connected to current collector plates 133 and 143 to be described later, and may be a current flow path between the negative electrode 121 and the positive electrode 122 and the outside thereof.

The separator 123 may be interposed between the negative electrode 121 and the positive electrode 122 to prevent direct contact between the negative electrode 121 and the positive electrode 122. Simultaneously, the separator 123 may include fine-sized pores in the surface to enable movement of lithium ions included in the electrolyte to be described later.

The separator 123 may be formed of polyethylene (PE) or polypropylene (PP). However, the material of the separator 123 is not limited thereto.

An electrolyte may be accommodated inside the case 110 together with the electrode assembly 120. For example, the electrolyte may contain lithium salt such as LiPF₆, LiBF₄ or the like in an organic solvent such as ethylene carbonate (EC), propylene carbonate (PC), diethyl carbonate (DEC), ethyl methyl carbonate (EMC) or dimethyl carbonate (DMC). In addition, the electrolyte may have a liquid, solid or gel phase.

On the other hand, according to an embodiment, the prismatic secondary battery cell 100 may include a short-circuit inductor 150. The short-circuit inductor 150 may be accommodated inside the case 110 together with the electrode assembly 120 and the electrolyte described above.

A detailed description of the short-circuit inductor 150 will be described later.

According to an embodiment, the case 110 may include an opening in at least one side, and a cap plate assembly may be disposed in the opening to cover the opening.

Referring to FIGS. 1 and 2, the case 110 may include openings in both sides in the longitudinal direction, and cap plate assemblies 130 and 140 may be disposed in respective openings. For example, according to the embodiment illustrated in FIGS. 1 and 2, the secondary battery cell 100 may include two cap plate assemblies 130 and 140.

In the following description, the first cap plate assembly 130 is a cap plate assembly disposed on the left side of the case 110 in the longitudinal direction based on the drawing, and the second cap plate assembly 140 is a cap plate assembly disposed on the right side of the case 110 in the longitudinal direction based on the drawing.

The first and second cap plate assemblies 130 and 140 may include first and second cap plates 131 and 141 covering the openings.

The first and second cap plates 131 and 141 may be coupled to the case 110. For example, the first and second cap plates 131 may be formed of an aluminum material and may be coupled to the case 110 by welding.

The first and second cap plate assemblies 130 and 140 may include first and second terminal plates 132 and 142.

The first and second terminal plates 132 and 142 may be disposed on outer sides of the first and second cap plates 131 and 141, and may be electrically connected to the negative electrode 121 or the positive electrode 122 of the electrode assembly 120 to have a polarity. For example, the first and second terminal plates 132 and 142 may be a negative terminal and a positive terminal, respectively.

For example, the first terminal plate 132 is formed of a material such as copper that may be a material of the negative electrode 121, and may be electrically connected to the negative electrode 121 of the electrode assembly 120 to have a negative electrode polarity. On the other hand, the second terminal plate 142 is formed of a material such as aluminum that may be the material of the positive electrode 122, and may be electrically connected to the positive electrode 122 of the electrode assembly 120 to have a positive electrode polarity.

In more detail, the first and second cap plates 130 and 140 may include first and second current collector plates 133 and 143, and the first and second terminal plates 132 and 142 may be electrically connected to the first and second current collector plates 133 and 143, respectively.

The first and second current collector plates 133 and 143 may be formed of a material that may serve as the negative electrode 121 or the positive electrode 122. For example, the first current collector plate 133 is formed of a material such as copper, and the first current collector plate 143 may be formed of a material such as aluminum.

The uncoated portions 121a and 122a of the electrode assembly 120 may be structurally and electrically connected to the first and second current collector plates 133 and 143. The uncoated portions 121a and 122a may be coupled to the first or first current collector plates 133 and 143 by welding, and thus the first and second current collector plates 133 and 143 may have a negative polarity or a positive polarity.

The first and second terminal plates 132 and 142 may be electrically connected to the first and first current collector plates 133 and 143 having a polarity of the negative electrode 121 or the positive electrode 122, and accordingly, may have negative or positive polarity.

Referring to the drawing, the first and second terminal plates 132 and 142 may be electrically connected to the first and first current collector plates 133 and 143 through first and second connection pins 134 and 144.

The first and second connection pins 134 and 144 may have lengths extending from the inside to the outside of the case 110. One sides of the first and second connection pins 134 and 144 are coupled to the first and second current collector plates 133 and 143 by welding, and the other sides may pass through the first and second cap plates 131 and 141 and the first and second terminal plates 132 and 142 in order and be coupled to the first and second terminal plates 132 and 142 by welding.

The first and second cap plates 131 and 141 and the second and second terminal plates 132 and 142 may include through-holes into which the first and second connection pins 134 and 144 are inserted. However, as described above, the structure in which the terminal plate and the connection pin are connected is only an embodiment of the cap plate assembly, and various modified structures may also be applied.

On the other hand, the first cap plate assembly 130 may further include components for insulation. For example, the first cap plate assembly 130 may include insulating plates 135a and 135b formed of polymer and a gasket 136.

The insulating plates 135a and 135b are disposed between the first cap plate 131 and the first current collector plate 133 and between the first cap plate 131 and the first terminal plate 132, to electrically insulate components disposed adjacently to each other.

For example, in the case of the first cap plate assembly 130, insulating plates 135a and 135b may be disposed on inner and outer sides of the first cap plate 131, respectively. However, in the modified structure, one of the insulating plates 135a and 135b may be omitted.

The gasket 136 may be provided to be inserted into the outer circumferential surface of the first connection pin 134 to electrically insulate the first connection pin 134 from the first cap plate 131. In addition, the gasket 136 may improve the sealing force of the case 110.

Although the first cap plate assembly 130 is described in the present specification as including the above-described insulation components, in the case of the second cap plate assembly 140, the above components may also be selectively included as needed.

In addition, although omitted in the present specification and drawings, the cap plate assembly may include an electrolyte inlet, a vent, and the like, and these configurations may be provided in the cap plate.

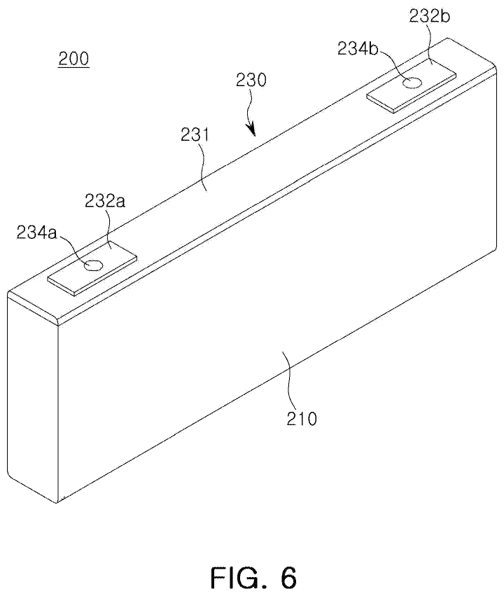

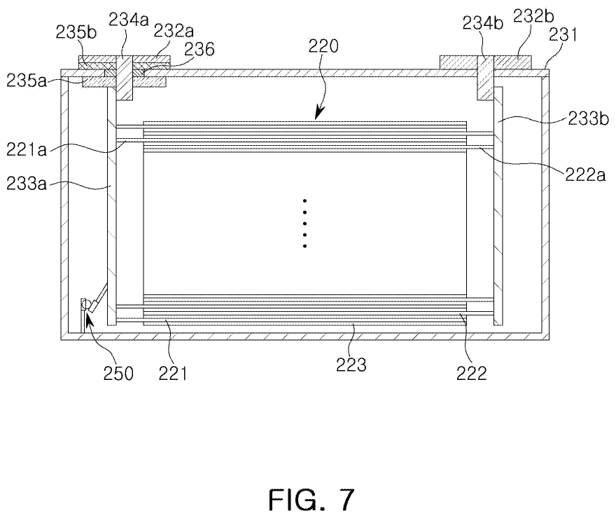

FIG. 6 is a perspective view of a secondary battery cell according to another embodiment, and FIG. 7 is an internal cross-sectional view of the secondary battery cell of FIG. 6.

According to another embodiment, a secondary battery cell 200 may include an opening in one side of a case 210 in the height direction, and a cap plate assembly 230 may be disposed in the opening. For example, according to the embodiment illustrated in FIGS. 6 and 7, the secondary battery cell 200 may include a single cap plate assembly 230 (hereinafter referred to as a third cap plate assembly).

The third cap plate assembly 230 may include a third cap plate 231 covering the opening. The third cap plate 231 may be coupled to the case 210.

The third cap plate assembly 230 may include third and fourth terminal plates 232a and 232b. The third and fourth terminal plates 232a and 232b may be spaced apart from the outer side of the third cap plate 231 in the longitudinal direction of the third cap plate 231.

Also, the third and fourth terminal plates 232a and 232b may be electrically connected to the negative electrode 221 or the positive electrode 222 of the electrode assembly 220 to have a polarity. For example, the third and fourth terminal plates 232a and 232b may be a negative terminal and a positive terminal, respectively.

The third cap plate assembly 230 may include third and fourth current collector plates 233a and 233b. The third and fourth terminal plates 232a and 232b may be electrically connected to the third and fourth current collector plates 233a and 233b, respectively.

The third and fourth current collector plates 233a and 233b may be structurally and electrically connected to the uncoated portions 221a and 222a of the electrode assembly 220, to have negative or positive polarities. The third and fourth terminal plates 232a and 232b are electrically connected to the first and first current collector plates 233a and 233b, and may thus have negative or positive polarities.

Referring to the drawing, the third and fourth terminal plates 232a and 232b may be electrically connected to the third and fourth current collector plates 233a and 233bg through the third and fourth connection pins 234a and 234b.

One sides of the third and fourth connection pins 234a and 234b are welded to the third and fourth current collector plates 233a and 233b, and the other sides thereof may sequentially pass through the third cap plate 231 and the third or fourth terminal plates 232a and 232b and be coupled to the third and fourth terminal plates by welding.

The third cap plate 231 and the third and fourth terminal plates 232a and 232b may include through-holes into which the third and fourth connection pins 234a and 234b are inserted.

On the other hand, the third cap plate assembly 230 may further include components for insulation on the side of the third terminal plate 232a.

For example, the third cap plate assembly 230 may include insulating plates 235a and 235b on inner and outer sides of the third cap plate 231, respectively, and may include a gasket 236 fitted to the outer circumferential surface of the third connection pin 234a.

The secondary battery cell 200 according to the embodiment illustrated in FIGS. 6 and 7 differs from the secondary battery cell 100 according to the embodiment illustrated in FIGS. 1 and 2, in terms of the number of the cap plate assemblies, arrangement positions thereof, and some structures changed accordingly, and the remaining structures except for these differences may be applied equally. In the above description, descriptions of parts applied equally to the descriptions of the secondary battery cell 100 of FIGS. 1 and 2 are omitted.

On the other hand, as described above, the secondary battery cell 100 according to an embodiment may include the short-circuit inductor 150.

The short-circuit inductor 150 is disposed inside the case 110 and is configured to induce an electrical short between a member having a negative polarity and a member having a positive polarity when the inside of the case 110 is a predetermined temperature or higher, to prevent ignition of battery cells.

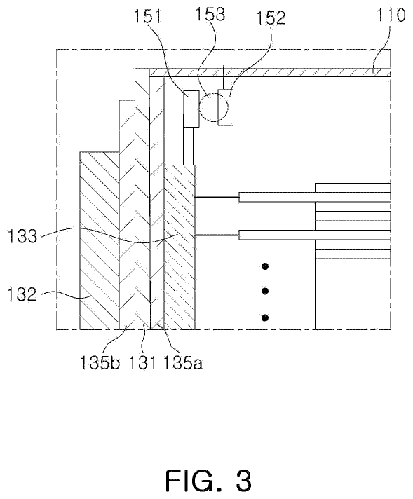

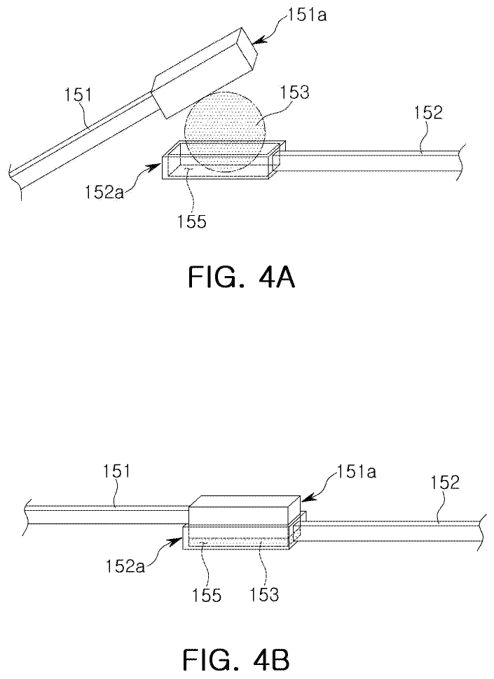

FIG. 3 is an enlarged view of a portion to which a short-circuit inductor is applied in FIG. 2, FIG. 4A is a diagram illustrating the state before the operation of the short-circuit inductor, and FIG. 4B is a diagram illustrating the state after the operation of the short-circuit inductor.

According to an embodiment, the short-circuit inductor 150 may be provided inside the case 110 in a form structurally connected to other components of the secondary battery cell 100.

Referring to FIG. 3, the short-circuit inductor 150 may include a first structure 151, a second structure 152, and an insulating structure 153.

In the short-circuit inductor 150, the first structure 151 and the second structure 152 are formed of a material conducting electricity, and the insulating structure 153 may be formed of an insulating material.

The first structure 151 and the second structure 152 may be structurally connected to surrounding structures. For example, the first structure 151 may be connected to a member having a negative polarity, and the second structure 152 may be connected to a member having a positive polarity. As another example, the first structure 151 may be connected to a member having a positive polarity, and the second structure 152 may be connected to a member having a negative polarity. In detail, the first structure 151 and the second structure 152 may be connected to members having different polarities to induce electrical shorting.

In an embodiment in which the first structure 151 is connected to a member having a negative polarity and the second structure 152 is connected to a member having a positive polarity, the first structure 151 may be connected to the first current collector plate 133 of the first cap plate assembly 130, and the second structure 152 may be connected to the case 110.

Also, in this case, the first structure 151 is formed of the same material as a material of the first current collector plate 133 or a material that may be the negative electrode 121, and the second structure 152 may be formed of the same material as a material of the case 110 or a material that may be the positive electrode 122.

According to an embodiment, the second structure 152 is not connected to the second current collector plate 143 of the second cap plate assembly 140, and may be connected to the case 110 having a positive polarity. This structure may significantly reduce the loss of energy density by reducing the space occupied by the short-circuit inductor 150 inside the case 110, and may reduce possibility of causing an unintentional short circuit by contacting the first structure 151 and/or the second structure 152 with other conductive members inside the case 110 due to an external impact or the like.

The insulating structure 153 may be disposed between the first structure 151 and the second structure 152. The insulating structure 153 may be provided in a state of being in contact with the first and second structures 151 and 152 simultaneously. An adhesive material may be applied to a contact portion between the insulating structure 153 and the first and second structures 151 and 152, or the contact portion may be maintained in contact with each other by thermal fusion.

According to an embodiment, the short-circuit inductor 150 may be operated by melting the insulating structure 153.

In detail, the first structure 151 and the second structure 152 may be spaced apart from each other by the insulating structure 153. For example, when the inside of the case 110 is lower than a predetermined temperature, the first structure 151 and the second structure 152 are not in contact with each other by the insulating structure 153, and may be maintained in a state being separated from each other. To this end, the insulating structure 153 may be in a solid state lower than a predetermined temperature.

On the other hand, the insulating structure 153 may be melted at a predetermined temperature or higher. For example, when the inside of the case 110 is a predetermined temperature or higher, the first structure 151 and the second structure 152 may come into contact with each other at least partially as the insulating structure 153 is melted and flows around.

For example, according to an embodiment, when the inside of the case 110 is a predetermined temperature or higher, as the first structure 151 having a negative polarity and the second structure 152 having a positive polarity come into partial contact, an internal short circuit may be induced, and accordingly, the secondary battery cell 100 may be in a state in which charging is no longer possible.

The first structure 151 and the second structure 152 may include portions facing each other with at least the insulating structure 153 interposed therebetween, to partially contact each other as the insulating structure 153 is melted. For example, referring to the drawings, the first structure 151 and the second structure 152 may be disposed such that at least ends 151a and 152a face each other with the insulating structure 153 interposed therebetween.

According to an embodiment, the insulating structure 153 may have a spherical shape as illustrated in the drawing to smooth the contact between the first structure 151 and the second structure 152 when the insulating structure 153 is melted. However, the shape of the insulating structure 153 is not limited thereto, and may be provided in various shapes within the scope of not interfering with the contact of the ends 151a and 152a of the first structure 151 and the second structure 152, and the size of the insulating structure 153 may also be changed depending on the shape of the insulating structure 153.

According to an embodiment, at least one of the first structure 151 and the second structure 152 may include a void 155 at least in a portion disposed to face the other.

In an embodiment, referring to the drawings, the second structure 152 may include the void 155 in an end 152a facing the first structure 151. In detail, the end 151a of the first structure may be disposed to face the end 152a of the second structure, for example, the void 155, with the insulating structure 153 interposed therebetween.

The insulating structure 153 may be disposed in the void 155. In this case, only a portion of the insulating structure 153 may be accommodated in the void 155.

Referring to FIG. 4A, a portion of the insulating structure 153 may be provided outside of the void 155, and the first structure 151 and the second structure 152 may maintain a spaced state before the insulating structure 153 is melted. Therefore, contact (unintentional short circuit) between the first structure 151 and the second structure 152 may be prevented.

In addition, as illustrated in FIG. 4B, when the inside of the case 110 becomes a predetermined temperature or higher by the above structure, the insulating structure 153 in a molten state may flow into the void 155. On the other hand, as illustrated in FIG. 4B, the end 151a of the first structure disposed to face the void 155 may also be accommodated in the void 155 as the insulating structure 153 is melted. To this end, the end 151a of the first structure and the end 152a of the second structure may be formed such that portions facing each other have different cross-sectional areas, and an end provided in the void 155 may be formed to have a relatively wider cross-sectional area.

According to an embodiment, the insulating structure 153 should react to the temperature in advance than other structures, and may thus be formed of a material having a relatively low melting point. For example, the insulating structure 153 may be formed of a polymer material having a melting point of 110° C. or more and 150° C. or less, and in detail, may be formed of solid or waxy polyethylene (PE) material or polypropylene (PP) material. However, the material of the insulating structure 153 is not limited thereto, and may be replaced with other materials having similar characteristics.

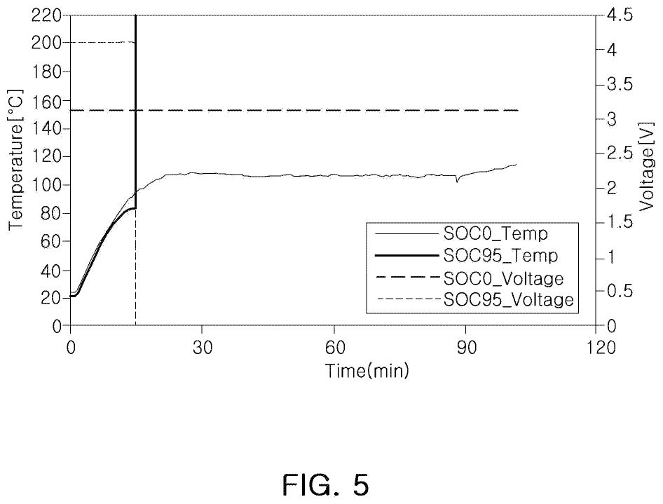

FIG. 5 is a graph of the stability test results of a secondary battery cell according to an embodiment of the disclosed technology.

The graph of FIG. 5 illustrates changes in temperature and voltage over time when the same level of heat is applied in the SOC 0 state and the SOC 95 state, respectively. In the case of SOC 0, the voltage was kept constant until the end of the experiment and the temperature rise was limited, whereas in the case of SOC 95, ignition occurred around 15 minutes after the experiment.

In the secondary battery cell 100 according to an embodiment of the disclosed technology, when the inside of the case 110 is a predetermined temperature or higher, a short circuit is intentionally induced and the voltage drops, and accordingly, since an event occurs at a smoke level or is ignited at a low temperature, an event may be prevented from deteriorating by delaying heat propagation.

As described above, the secondary battery cell 100 according to an embodiment includes the short-circuit inductor 150 inducing an electrical short at a predetermined temperature or higher, and thus, the stability of the secondary battery cell 100 may be improved. In detail, since the short-circuit inductor 150 is applied to a prismatic secondary battery cell having most structural stability, the secondary battery cell 100 greatly advantageous in terms of stability may be provided.

The above description of the short-circuit inductor 150 is provided based on the secondary battery cell 100 according to the embodiment illustrated in FIGS. 1 and 2, but may also be equally applied to the secondary battery cell 200 according to the embodiment illustrated in FIGS. 6 and 7. In the accompanying drawings, it is illustrated that the case 210 includes the short-circuit inductor 250 according to an embodiment. For example, the secondary battery cell 200 illustrated in FIGS. 6 and 7 is different from the secondary battery cell 100 illustrated in FIGS. 1 and 2 in that the cap plate assembly 230 is disposed on one side of the case 210 in the height direction and the negative terminal 232a and the positive terminal 232b are provided on the single cap plate 231, and other concepts may be equally applied.

As set forth above, in the secondary battery cell according to an embodiment, as an electrical short is induced at a predetermined temperature or higher, the voltage drops and the possibility of ignition may be significantly lowered, and accordingly, safety may be improved.

Only specific examples of implementations of certain embodiments are described. Variations, improvements and enhancements of the disclosed embodiments and other embodiments may be made based on the disclosure of this patent document.

What is claimed is:

1. A secondary battery cell comprising:
an electrode assembly having a negative electrode and a positive electrode alternately stacked with a separator therebetween;
a case accommodating the electrode assembly and including an opening in at least one side;
a cap plate assembly disposed to cover the opening and including at least one of a negative electrode terminal connected to the negative electrode and a positive electrode terminal connected to the positive electrode; and
a short-circuit inductor accommodated inside of the case and inducing a short circuit between a member having a negative polarity and a member having a positive polarity when the inside of the case is at a predetermined temperature or higher.

2. The secondary battery cell of claim 1, wherein the short-circuit inductor includes,
a first structure formed of a conductive material connected to the member having the negative polarity;
a second structure formed of a conductive material connected to the member having the positive polarity; and
an insulating structure formed of an insulating material contacting the first structure and the second structure simultaneously.

3. The secondary battery cell of claim 2, wherein the insulating structure is disposed between the first structure and the second structure and is a solid-state material having an arbitrary shape.

4. The secondary battery cell of claim 3, wherein the first structure and the second structure maintain a state of being spaced apart from each other by the insulating structure when the inside of the case is lower than a predetermined temperature, and
are at least partially in contact with each other when the inside of the case is a predetermined temperature or higher.

5. The secondary battery cell of claim 3, wherein the first structure and the second structure are disposed such that respective ends face each other with the insulating structure interposed therebetween.

6. The secondary battery cell of claim 5, wherein at least one of the first structure and the second structure includes a void in an end, and
a portion of the insulating structure is disposed in the void.

7. The secondary battery cell of claim 6, wherein the void has a cross-sectional area larger than a cross-sectional area of the end of the first structure or the second structure facing the void, where the end of the first structure or the second structure facing the void is not a void.

8. The secondary battery cell of claim 2, wherein the insulating structure is formed of a material having a melting point of 110° C. or more and 150° C. or less.

9. The secondary battery cell of claim 8, wherein the insulating structure is formed of a polyethylene (PE) material or a polypropylene (PP) material.

10. The secondary battery cell of claim 2, wherein the case is formed of a material containing aluminum, and the second structure is connected to the case.

11. The secondary battery cell of claim 10, wherein the second structure is formed of the same material as a material of the case.

12. The secondary battery cell of claim 2, wherein the electrode assembly includes an uncoated portion led out in a longitudinal direction of the negative electrode or the positive electrode,
the cap plate assembly includes a current collector plate structurally and electrically connected to the uncoated portion, and
the first structure is connected to the current collector plate.

13. The secondary battery cell of claim 12, wherein the first structure is formed of the same material as a material of the current collector plate.

14. The secondary battery cell of claim 1, wherein the case has a rectangular parallelepiped shape.
